(19) United States
(12) Patent Application Publication
(10) Pub. No.: US 2023/0378675 A1
(43) Pub. Date: Nov. 23, 2023

(54) USB TYPE-C FEMALE CONNECTOR

(71) Applicant: AMPHENOL EAST ASIA ELECTRONIC TECHNOLOGY (SHEN ZHEN) CO., LTD., Shen zhen (CN)

(72) Inventors: ZE-FENG LAI, SHEN ZHEN (CN); ZHI-MIN QIN, SHEN ZHEN (CN); GENG-GENG CHEN, SHEN ZHEN (CN); LEI LIAO, SHEN ZHEN (CN)

(21) Appl. No.: 17/747,876

(22) Filed: May 18, 2022

(51) Int. Cl. H01R 13/10; H01R 13/502; H01R 24/60; H01R 13/405

(52) U.S. Cl. CPC H01R 13/10; H01R 13/5025; H01R 24/60; H01R 13/405; H01R 2107/00

(57) ABSTRACT

A USB type-C female connector includes an inner and an outer iron case, a terminal set, a plastic member, and a middle steel plate. The terminal set includes a terminal set A and a terminal set B. The terminal set A and terminal set B are in an upper and a lower terminal groove, respectively; the middle steel plate is in the middle steel plate slot. The plastic member is in the inner iron case; the inner iron case is in the outer iron case. The grounding terminal and the power terminal are formed of highly conductive copper material having a 0.20 to 0.30 mm thickness and a conductivity over 80%. The tongue plate area of the second terminal foot set A and second terminal foot set B facing the middle steel plate is thinned by 0.02 mm, improving impedance and optimizing insertion loss and return loss.

### BACKGROUND OF THE INVENTION

### 1. Field of the Invention

The present invention relates to connectors, and more particularly, to a USB type-C female connector with high-speed transmission and large-current fast charging function.

### 2. Description of the Related Art

With the advancement of science and technology, connectors have a function of plug and play which is widely used now. With the continuous acceleration of data transmission, the transmission rate required is continuously increasing.

Also, when the development of large batteries becomes popular, charging time of the batteries become the mostly concerned factors for users. Current products in the market are gradually unable to meet higher requirements.

### SUMMARY OF THE INVENTION

The present invention aims at optimizing the terminal foot of the connectors, so as to achieve the high-speed transmission capability and large-current fast charging function.

For achieving the aforementioned objectives, the present invention provides a USB type-C female connector, comprising an inner iron case, an outer iron case, a terminal set, a plastic member, and a middle steel plate, the terminal set comprising a terminal set A and a terminal set B; the terminal set A and the terminal set B being symmetrically arranged;

the terminal set and the plastic member being formed through primary molding; a joint part of the plastic member and the terminal set being provided with an upper terminal groove and a lower terminal groove; the primarily molded terminal sets and plastic member being added with a middle steel plate through secondary molding; a joint part of the plastic member and the middle steel plate being provided with a middle steel plate slot;

the upper terminal groove being disposed above the middle steel plate slot; the lower terminal groove being disposed below the middle steel plate slot; the terminal set A being disposed in the upper terminal groove; the terminal set B being disposed in the lower terminal groove; the middle steel plate being disposed in the middle steel plate slot;

the plastic member being inserted in the inner iron case; the inner iron case being inserted in the outer iron case;

the terminal set A comprising a distal terminal foot set A, a first terminal foot set A, and a second terminal foot set A; wherein the distal terminal foot set A is disposed on two distal ends; wherein the first terminal foot set A and the second terminal foot set A are disposed in the middle of the distal terminal foot set A;

the terminal set B comprising a distal terminal foot set B, a first terminal foot set B, and a second terminal foot set B; wherein the distal terminal foot set B is disposed on two distal ends; wherein the first terminal foot set B and the second terminal foot set B are disposed in the middle of the distal terminal foot set B;

wherein the distal terminal foot set A and the distal terminal foot set B are symmetrically arranged in alignment in an up-and-down direction; wherein the first terminal foot set A and the first terminal foot set B are arranged in alignment in an up-and-down direction; wherein the second terminal foot set A and the second terminal foot set B are arranged in alignment in an up-and-down direction;

an area of a bottom face of the distal terminal foot set A and of the distal terminal foot set B facing the middle steel plate being thinned by 0.0 6mm, such that the plastic member is filled between the bottom face and the middle steel plate, so as to prevent hollow and short circuit from happening,

a bottom portion of a tongue plate area of the second terminal foot set A and of the second terminal foot set B facing the middle steel plate being thinned by 0.02 mm, so as to improve an impedance and optimize insertion loss and return loss.

Preferably, the terminal set comprises a highly conductive copper material which has two thicknesses and a conductivity over 80%; one of the two thicknesses ranges from 0.20 to 0.30 mm which is a thickness of the distal terminal foot set A, the first terminal foot set A, the distal terminal foot set B, and the first terminal foot set B; the other one of the two thicknesses ranges from 0.1 to 0.15 mm which is a thickness of rest parts of the terminal.

Preferably, a face of the middle steel plate corresponding to the second terminal foot set A and the second terminal foot set B is not perforated, so as to improve near-end crosstalk and far-end crosstalk between high-speed signal pair.

Preferably, a point of the distal terminal foot set A and a point of the distal terminal foot set B that are in parallel and reversely bent contact the middle steel plate, so as to improve crosstalk between high-speed signal pair and optimize resonance.

Preferably, an inward elastic arm is disposed on the inner iron case; a groove is disposed on the plastic member; the inward elastic arm is engaged with the groove.

Preferably, an outward elastic arm is disposed on the inner iron case; an engagement recess is disposed on the outer iron case; the outward elastic arm is engaged with the engagement recess.

Preferably, the terminal set A comprising twelve terminal feet; the terminal set B comprises twelve terminal feet.

With such configuration, the present invention achieves following advantages:

The USB type-C female connector comprises technical features which optimize the terminal structures. The grounding terminal and the power terminal is formed of highly conductive copper material having a thickness ranging from 0.20 to 0.30 mm and a conductivity over 80%. The high-speed terminal pair has the bottom portion of their tongue plate areas thinned by 0.02 mm, so as to improve the impedance and optimize insertion loss and return loss. The face of the middle steel plate corresponding to high-speed terminal pair and the signal terminal is not perforated, so as to improve near-end crosstalk and far-end crosstalk between high-speed signal pair. The grounding terminal contacts the middle steel plate, so as to improve the crosstalk between high-speed signal pair and optimize resonance

### BRIEF DESCRIPTION OF THE DRAWINGS

FIG. 1 is an exploded view of the USB type-C female connector in accordance with an embodiment of the present invention.

FIG. 2 is a schematic view of the USB type-C female connector in accordance with an embodiment of the present invention.

FIG. 3 is a schematic view of the terminal set A of the USB type-C female connector in accordance with an embodiment of the present invention.

FIG. 4 is a schematic view of the terminal set B of the USB type-C female connector in accordance with an embodiment of the present invention.

FIG. 5 is a first sectional view of the USB type-C female connector in accordance with an embodiment of the present invention.

FIG. 6 is a second sectional view of the USB type-C female connector in accordance with an embodiment of the present invention.

### DETAILED DESCRIPTION OF THE INVENTION

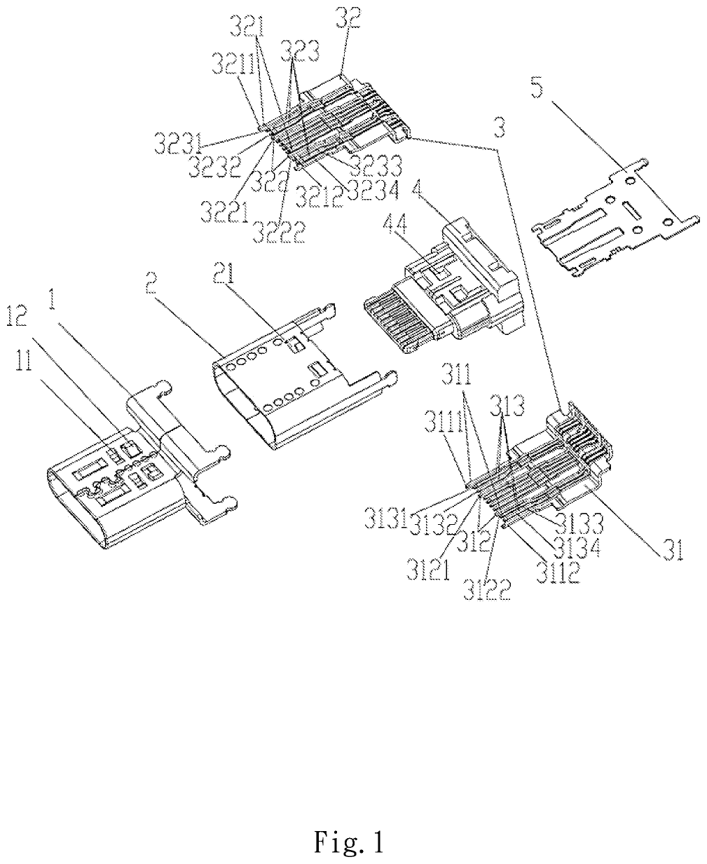

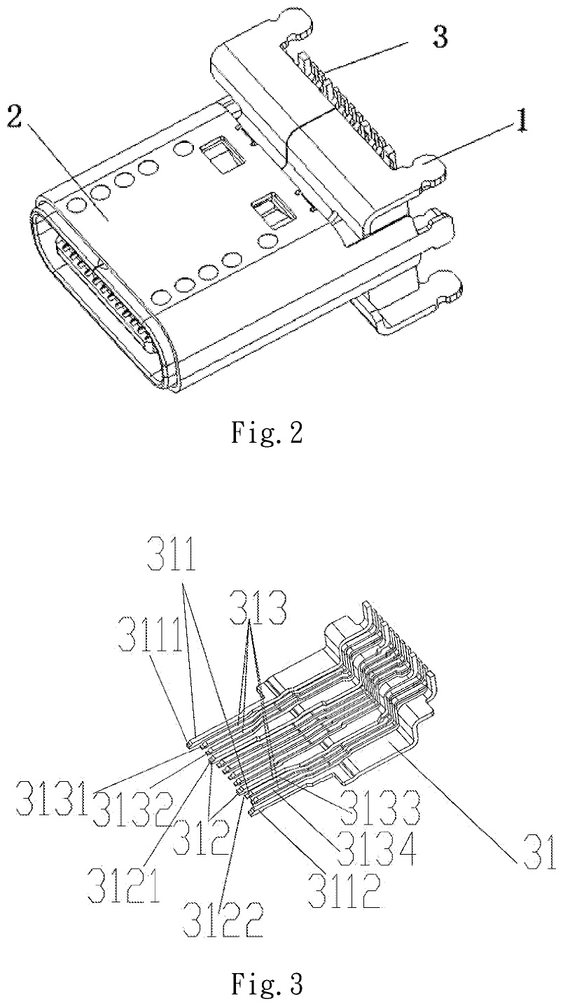

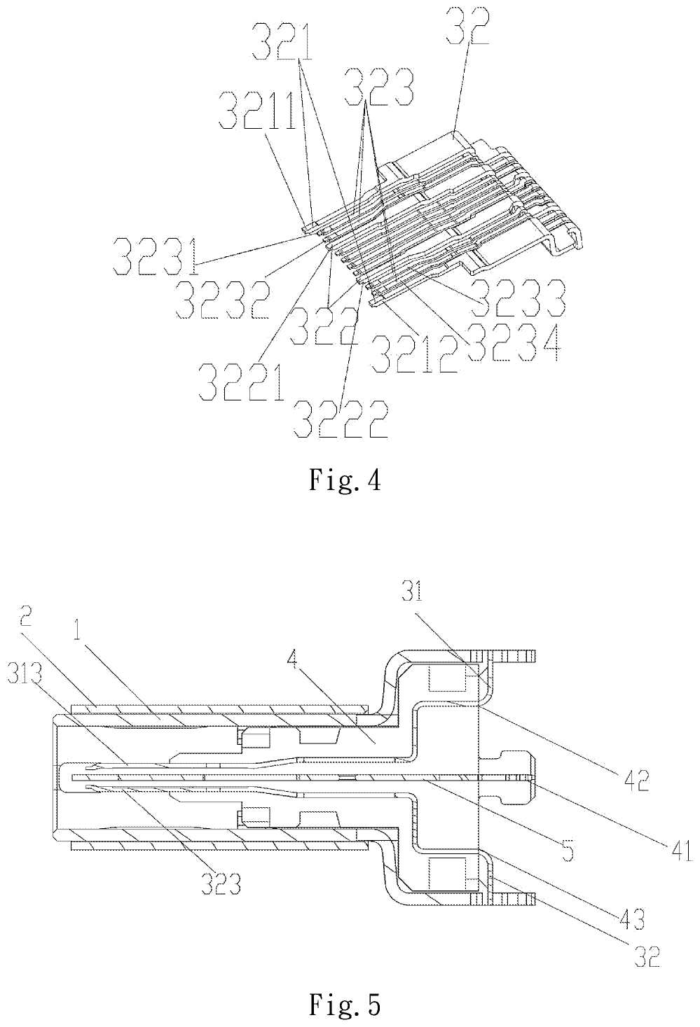

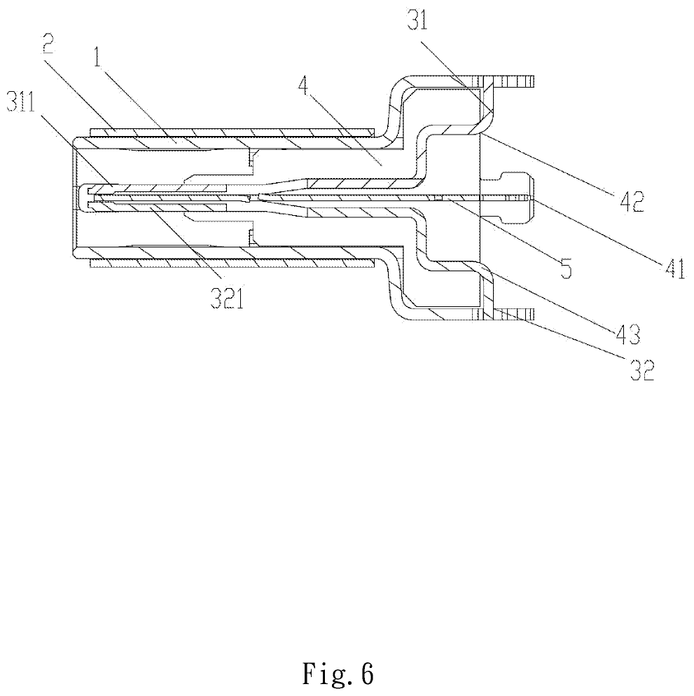

The aforementioned and further advantages and features of the present invention will be understood by reference to the description of the preferred embodiment in conjunction with the accompanying FIG. 1 to FIG. 6 where the components are illustrated based on a proportion for explanation but not for limiting the present invention.

### Embodiment 1

Referring to FIG. 1 to FIG. 6, the present invention provides a USB type-C female connector, comprising an inner iron case 1, an outer iron case 2, a terminal set 3, a plastic member 4, and a middle steel plate 5, the terminal set comprising a terminal set A 31 and a terminal set B 32; and the terminal set A 31 and the terminal set B 32 being symmetrically arranged. The terminal set A 31 comprises twelve terminal feet, namely the first terminal foot A, the second terminal foot A, the third terminal foot A, the fourth terminal foot A, the fifth terminal foot A, the sixth terminal foot A, the seventh terminal foot A, the eighth terminal foot A, the ninth terminal foot A, the tenth terminal foot A, the eleventh terminal foot A, and the twelfth terminal foot A. The terminal set B 32 comprises twelve terminal feet, namely the first terminal foot B, the second terminal foot B, the third terminal foot B, the fourth terminal foot B, the fifth terminal foot B, the sixth terminal foot B, the seventh terminal foot B, the eighth terminal foot B, the ninth terminal foot B, the tenth terminal foot B, the eleventh terminal foot B, and the twelfth terminal foot B.

The terminal set 3 and the plastic member 4 are formed through primary molding; a joint part of the plastic member 4 and the terminal set 3 is provided with an upper terminal groove 42 and a lower terminal groove 43; the primarily molded terminal set 3 and plastic member 4 are added with a middle steel plate 5 through secondary molding; a joint part of the plastic member 4 and the middle steel plate 5 is provided with a middle steel plate slot 41.

The upper terminal groove 42 is disposed above the middle steel plate slot 41; the lower terminal groove 43 is disposed below the middle steel plate slot 41; the terminal set A 31 is disposed in the upper terminal groove 42; the terminal set B 32 is disposed in the lower terminal groove 43; the middle steel plate 5 is disposed in the middle steel plate slot 41.

The terminal set A 31 comprises a distal terminal foot set A 311, a first terminal foot set A 312, and a second terminal foot set A 313; wherein the distal terminal foot set A 311 is disposed on two distal ends; wherein the first terminal foot set A 312 and the second terminal foot set A 313 are disposed in the middle of the distal terminal foot set A 311.

Therein, the distal terminal foot set A 311 comprises the first terminal foot A 3111 and the twelfth terminal foot A 3112; wherein the first terminal foot set A 312 comprises the fourth terminal foot A 3121 and the ninth terminal foot A 3122; wherein the second terminal foot set A 313 comprises the second terminal foot A 3131, the third terminal foot A 3132, the tenth terminal foot A 3133, and the eleventh terminal foot A 3134.

The terminal set B 32 comprises a distal terminal foot set B 321, a first terminal foot set B 322, and a second terminal foot set B 323; wherein the distal terminal foot set B 321 is disposed on two distal ends; wherein the first terminal foot set B 322 and the second terminal foot set B 323 are disposed in the middle of the distal terminal foot set B 321.

Therein, the distal terminal foot set B 321 comprises the first terminal foot B 3211 and the twelfth terminal foot B 3212; wherein the first terminal foot set B 322 comprises the fourth terminal foot B 3221 and the ninth terminal foot B 3222; wherein the second terminal foot set B 323 comprises the second terminal foot B 3231, the third terminal foot B 3232, the tenth terminal foot B 3233, and the eleventh terminal foot B 3234.

Therein, the distal terminal foot set A 311 and the distal terminal foot set B 321 are symmetrically arranged in alignment in an up-and-down direction; wherein the first terminal foot set A 312 and the first terminal foot set B 322 are arranged in alignment in an up-and-down direction; wherein the second terminal foot set A 313 and the second terminal foot set B 323 are arranged in alignment in an up-and-down direction.

An inward elastic arm 11 is disposed on the inner iron case 1; a groove 44 is disposed on the plastic member 4; the inward elastic arm 11 is engaged with the groove 44.

An outward elastic arm 12 is disposed on the inner iron case 1; an engagement recess 21 is disposed on the outer iron case 2; the outward elastic arm 12 is engaged with the engagement recess 21.

Referring to FIG. 1 to FIG. 6, the practical embodiment of the USB type-C female connector is illustrated. The terminal set A 31 is inserted in the upper terminal groove 42; the terminal set B 32 is inserted in the lower terminal groove 43; the middle steel plate 5 is disposed in the middle steel plate slot 41; the plastic member 4 is inserted in the inner iron case 1; the inner iron case 1 is inserted in the outer iron case 2; an area of a bottom face of the distal terminal foot set A 311 and of the distal terminal foot set B 321 facing the middle steel plate is thinned by 0.06 mm, such that the plastic member 4 is filled between the bottom face and the middle steel plate 5, so as to prevent hollow and short circuit from happening; a bottom portion of a tongue plate area of the second terminal foot set A 313 and of the second terminal foot set B 323 facing the middle steel plate 5 is thinned by 0.02 mm, so as to improve an impedance and optimize insertion loss and return loss. The terminal set 3 comprises a highly conductive copper material which has two thicknesses and a conductivity over 80%, wherein one of the two thicknesses ranges from 0.20 to 0.30 mm which is a thickness of the distal terminal foot set A 311, the first terminal foot set A 312, the distal terminal foot set B 321, and the first terminal foot set B 322, and the other one of the two thicknesses ranges from 0.1 to 0.15 mm which is a thickness of rest parts of the terminal. A face of the middle steel plate 5 corresponding to the second terminal foot set A 313 and the second terminal foot set B 323 is not perforated, so as to improve near-end crosstalk and far-end crosstalk between high-speed signal pair. A point of the distal terminal foot set A 311 and a point of the distal terminal foot set B 321 that are in parallel and reversely bent contact the middle steel plate 5, so as to improve crosstalk between high-speed signal pair and optimize resonance. With the foregoing configuration, the present invention achieves the demand of a high-speed transmission capability and a large-current fast charging function.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A USB type-C female connector, comprising an inner iron case, an outer iron case, a terminal set, a plastic member, and a middle steel plate, the terminal set comprising a terminal set A and a terminal set B; the terminal set A and the terminal set B being symmetrically arranged;
the terminal set and the plastic member being formed through primary molding; a joint part of the plastic member and the terminal set being provided with an upper terminal groove and a lower terminal groove; the primarily molded terminal set and plastic member being added with a middle steel plate through secondary molding; a joint part of the plastic member and the middle steel plate being provided with a middle steel plate slot;
the upper terminal groove being disposed above the middle steel plate slot; the lower terminal groove being disposed below the middle steel plate slot; the terminal set A being disposed in the upper terminal groove; the terminal set B being disposed in the lower terminal groove; the middle steel plate being disposed in the middle steel plate slot;
the plastic member being inserted in the inner iron case; the inner iron case being inserted in the outer iron case;
the terminal set A comprising a distal terminal foot set A, a first terminal foot set A, and a second terminal foot set A; wherein the distal terminal foot set A is disposed on two distal ends; wherein the first terminal foot set A and the second terminal foot set A are disposed in the middle of the distal terminal foot set A;
the terminal set B comprising a distal terminal foot set B, a first terminal foot set B, and a second terminal foot set B; wherein the distal terminal foot set B is disposed on two distal ends; wherein the first terminal foot set B and the second terminal foot set B are disposed in the middle of the distal terminal foot set B;
wherein the distal terminal foot set A and the distal terminal foot set B are symmetrically arranged in alignment in an up-and-down direction; wherein the first terminal foot set A and the first terminal foot set B are arranged in alignment in an up-and-down direction; wherein the second terminal foot set A and the second terminal foot set B are arranged in alignment in an up-and-down direction;
an area of a bottom face of the distal terminal foot set A and of the distal terminal foot set B facing the middle steel plate being thinned by 0.06 mm, such that the plastic member is filled between the bottom face and the middle steel plate, so as to prevent hollow and short circuit from happening,
a bottom portion of a tongue plate area of the second terminal foot set A and of the second terminal foot set B facing the middle steel plate being thinned by 0.02 mm, so as to improve an impedance and optimize insertion loss and return loss.

2. The USB type-C female connector of claim 1, wherein the terminal set comprises a highly conductive copper material which has two thicknesses and a conductivity over 80%; one of the two thicknesses ranges from 0.20 to 0.30 mm which is a thickness of the distal terminal foot set A, the first terminal foot set A, the distal terminal foot set B, and the first terminal foot set B; the other one of the two thicknesses ranges from 0.1 to 0.15 mm which is a thickness of rest parts of the terminal.

3. The USB type-C female connector of claim 1, wherein a face of the middle steel plate corresponding to the second terminal foot set A and the second terminal foot set B is not perforated, so as to improve near-end crosstalk and far-end crosstalk between high-speed signal pair.

4. The USB type-C female connector of claim 1, wherein a point of the distal terminal foot set A and a point of the distal terminal foot set B that are in parallel and reversely bent contact the middle steel plate, so as to improve crosstalk between high-speed signal pair and optimize resonance.

5. The USB type-C female connector of claim 1, wherein an inward elastic arm is disposed on the inner iron case; a groove is disposed on the plastic member; the inward elastic arm is engaged with the groove.

6. The USB type-C female connector of claim 1, wherein an outward elastic arm is disposed on the inner iron case; an engagement recess is disposed on the outer iron case; the outward elastic arm is engaged with the engagement recess.

7. The USB type-C female connector of claim 1, wherein the terminal set A comprising twelve terminal feet; and the terminal set B comprises twelve terminal feet.
